(19) United States
(12) Patent Application Publication
(10) Pub. No.: US 2023/0058575 A1
(43) Pub. Date: Feb. 23, 2023

(54) PORTAL GEAR HUB WITH HEAT SINK FINS

(71) Applicant: Super ATV, LLC, Madison, IN (US)

(72) Inventors: Chris Shelton, Madison, IN (US); Justin L. Eaton, Hanover, IN (US)

(21) Appl. No.: 17/407,203

(22) Filed: Aug. 20, 2021

(51) Int. Cl. B60K 17/04; B62K 5/01; F16H 1/20; F16H 57/03; F16H 57/04

(52) U.S. Cl. CPC B60K 17/043; B62K 5/01; F16H 1/20; F16H 57/03; F16H 57/0416; F16H 2057/02056

(57) ABSTRACT

A portal gear box assembly for an all-terrain vehicle includes a portal gear box housing with a set of gears contained therein, and a plurality of heat-radiating fins extending from the housing wall and effective to radiate heat from the housing at a faster rate than would be radiated in the absence of the fins. The fins may extend outward or inward from the housing, and may be formed integrally with one or more of the walls of the housing, or may be removably attached to the housing. Preferred fins comprise a generally rectangular, planer surface extending radially from a wall of the housing.

### FIELD OF THE INVENTION

The present invention relates generally to portal wheel ends for lifting the wheels of an off road vehicle, such as an all-terrain vehicle (ATV) or a utility task vehicle (UTV), and more particularly to gear-reducing portal gear boxes.

### BACKGROUND OF THE INVENTION

Portal gear lifts are used by ATV and UTV enthusiasts to raise an off-road vehicle higher above the ground so that larger tires can be run on the vehicle. In addition, since larger diameter tires cover a greater distance with each rotation, portal gear lifts typically include gear reduction so that a single rotation of the vehicle power axle results in a slightly lesser rotation of the output axle. Further, the extra length provided by the output axle may allow the assembly to widen the wheelbase of the vehicle.

Portal gear lifts typically include sealed housings (boxes) that contain a fluid lubricant effective to lubricate the gears as the gears spin within the housing. Vigorous use may cause the gears and their lubricant to heat, and that heating may reduce the effectiveness of the lubricant and cause pressure to build up within the housing. Additionally, excess heat may damage seals, causing them to fail and allowing oil, etc., to leak from the box.

A need therefore exists for materials and methods for reducing portal gear box heating, and for avoiding, reducing, and/or relieving resulting pressure. The present invention addresses that need.

### SUMMARY OF THE INVENTION

In one aspect of the invention there is provided a portal gear box assembly for an all-terrain vehicle or a utility task vehicle. The assembly may comprise a portal gear box housing with a first opening for receiving the end of a vehicle axle, a second opening for an output shaft, and a set of gears to link the input shaft to the output shaft. To mitigate against the effects of heat build-up in the housing, one or more of the housing walls includes a plurality of heat-radiating fins effective to radiate heat from the housing at a faster rate than would be radiated in the absence of the fins.

The fins may extend outward from the adjacent outer surface of the housing, or they may extend inward. The fins may be formed by removing metal from one or more of the walls of the housing.

The fins may be removably attached to one or more of the walls of the housing, or they may be formed integrally with one or more of the walls of the housing.

The fins may comprise a generally rectangular, planer surface extending radially from a wall of the housing.

### BRIEF DESCRIPTION OF THE DRAWINGS

FIG. 1 is a first perspective view of one embodiment of the present invention.

FIG. 2 is a second perspective view of one embodiment of the present invention.

FIG. 3 is a third perspective view of one embodiment of the present invention.

FIG. 4 is a first exploded view of one embodiment of the present invention.

FIG. 5 is a second exploded view of one embodiment of the present invention.

FIG. 6 is a perspective view of another embodiment of the present invention.

### DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, such alterations and further modifications in the described device, and such further applications of the principles of the invention as illustrated therein, being contemplated as would normally occur to one skilled in the art to which the invention relates.

As indicated above, one aspect of the present invention relates to a portal gear box assembly for an all-terrain vehicle or a utility task vehicle. The assembly may comprise a portal gear box housing with a first opening for receiving the end of a vehicle axle, a second opening for an output shaft, and a set of gears to link the input shaft to the output shaft. To mitigate against the effects of heat build-up in the housing, one or more of the housing walls includes a plurality of heat-radiating fins effective to radiate heat from the housing at a faster rate than would be radiated in the absence of the fins. This transfers heat from the housing and from the gears and other components and materials inside of the housing, thus reducing the temperature of the assembly during use.

The fins may extend outward from the adjacent outer surface of the housing, or they may extend inward. Regardless of their orientation, the fins may be positioned such that a heat transfer fluid, which may be air, or oil, or another heat transferring fluid, may flow around the fin to facilitate heat transfer.

The fins may be formed by removing metal from one or more of the walls of the housing. The metal may be removed from the inside or the outside of the housing wall.

The fins may be removably attached to one or more of the walls of the housing, or they may be formed integrally with one or more of the walls of the housing.

The fins may comprise a generally rectangular, planer surface extending radially from a wall of the housing. In some embodiments, the fins have a more trapezoidal shape.

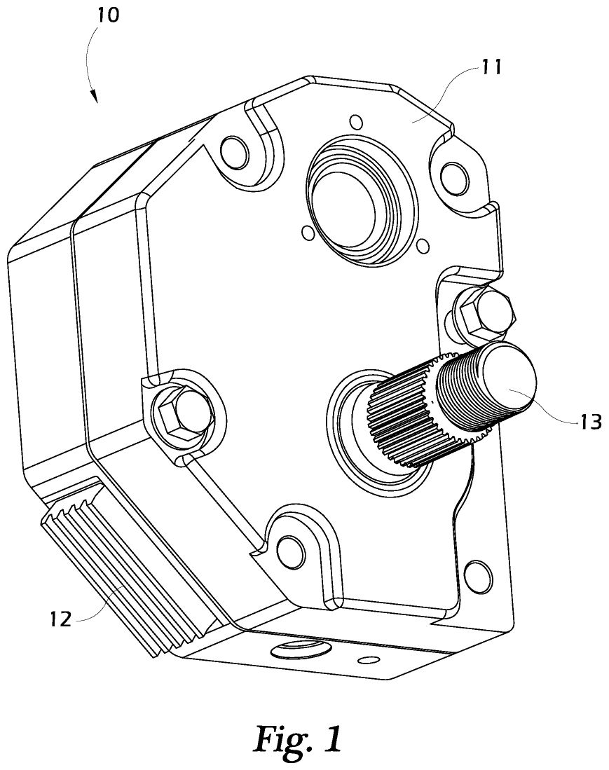

Referring now to the drawings, FIG. 1 is a first perspective view of one embodiment of the present invention. Portal gear box assembly 10 comprises a housing 11 with an output shaft 13 extending therefrom. A plurality of heat-radiating fins 12 extends from the housing, and are effective to radiate heat from the housing at a faster rate than would be radiated in the absence of the fins. The fins extend outward from the surface of the housing, and each fin comprises a generally rectangular, planer surface extending radially from a wall of the housing.

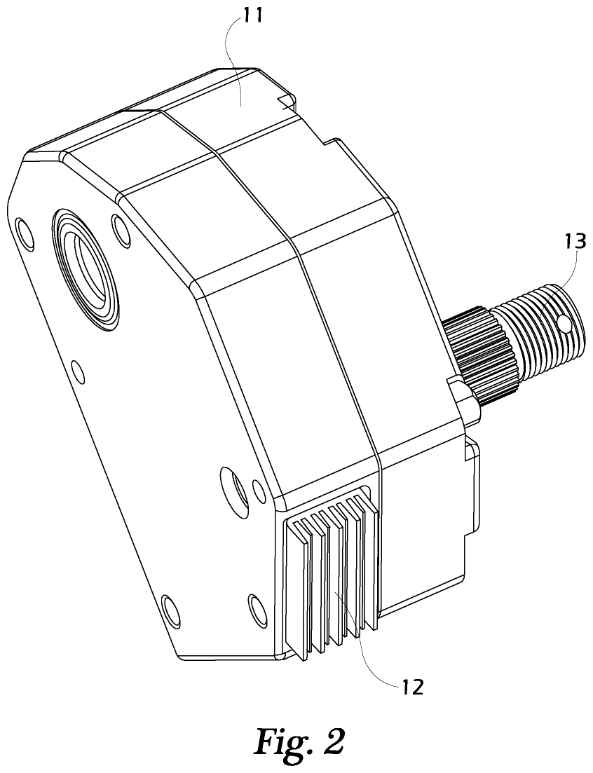

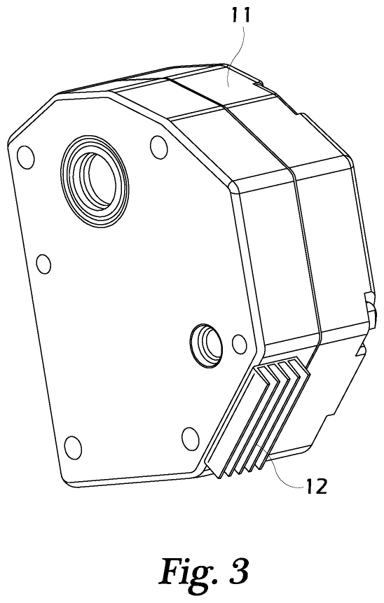

FIGS. 2 and 3 are additional perspective views of the embodiment of FIG. 1. Here too, a plurality of generally rectangular, planer fins extend radially from a wall of the housing in a manner effective to radiate heat from the housing.

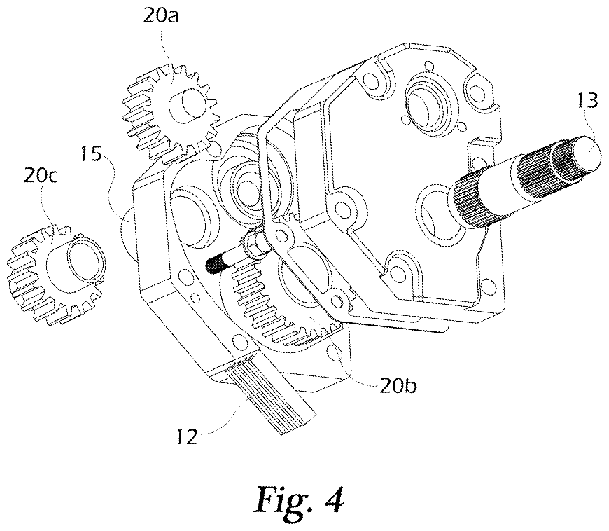

FIG. 4 is a first exploded view of one embodiment of the present invention. Portal gear box assembly 10 comprises a housing 11 with an output shaft extending therefrom. A plurality of gears 20 are provided in the housing to link an input shaft 15 to output shaft 13. Heat-radiating fins 12 extend from the housing, and are effective to radiate heat from the housing at a faster rate than would be radiated in the absence of the fins. The fins extend outward from the surface of the housing, and each fin comprises a generally rectangular, planer surface extending radially from a wall of the housing.

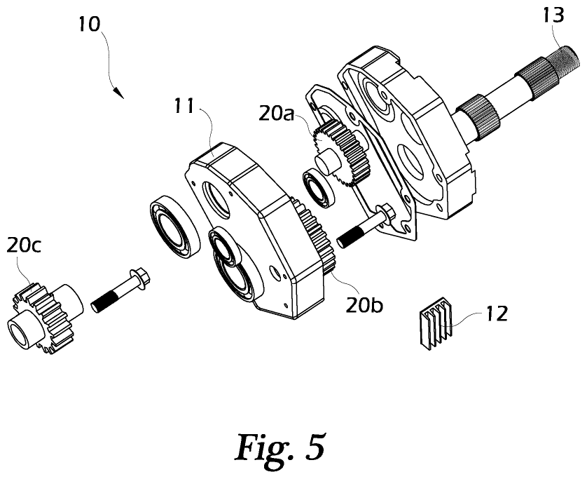

FIG. 5 is a second exploded view of one embodiment of the present invention, showing housing 11, gears 20, and fins 12.

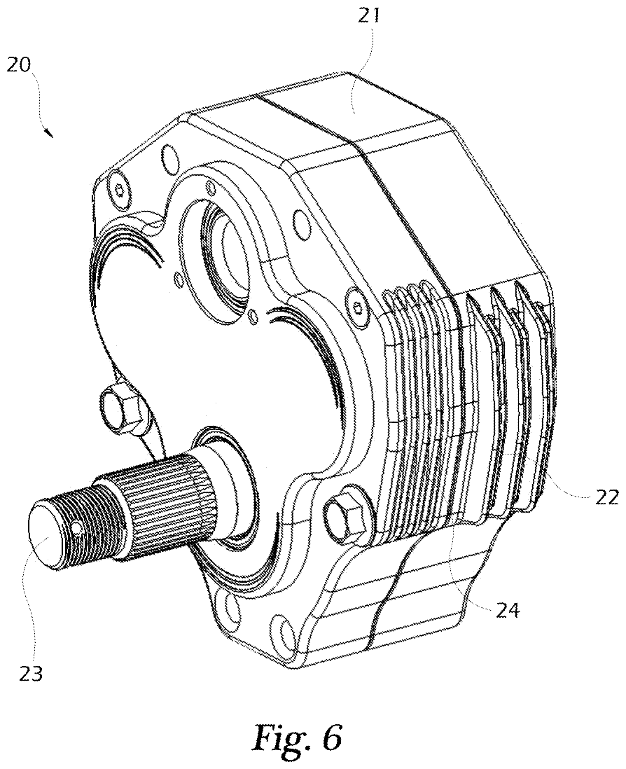

FIG. 6 shows another embodiment of the portal gear box assembly of the present invention. Assembly 20 comprises housing 21 with outwardly-extending fins 22 and inwardly-extending fins 24. In the illustrated embodiment, inwardly-extending fins 24 are formed by removing metal from the housing wall. Output shaft 23 is also shown.

As indicated above, it is to be appreciated that alternative embodiments may utilize different structural details to accomplish similar results. For example, while the illustrated fins are surrounded by air, they may be surrounded by oil or another heat conducting fluid that is effective to promote heat dissipation from the housing through the fins.

Also, while the illustrated fins each comprise a generally rectangular, planer surface, the fins may be provided in essentially any shape effective to promote heat dissipation from the housing through the fins.

Similarly, while the illustrated fins are formed as a unitary package of fins that may be removably attached to the walls of the housing, the fins may be formed integrally with one or more of the walls of the housing.

Lastly, while the illustrated fins are formed as separate pieces of metal that are attached to the housing, the fins may be formed by removing metal from one or more of the walls of the housing.

While the invention has been illustrated and described in detail in the foregoing description and drawings, the same are to be considered as illustrative and not restrictive in character, it being understood that only certain preferred embodiments have been shown and described, and that all changes and modifications that come within the spirit of the invention are desired to be protected.

Additionally, it is to be appreciated that the present invention may comprise or consist essentially of any or all of the described ingredients in their disclosed amounts, and that any or all of the ingredients, amounts, features, elements, and/or embodiments disclosed herein may be combined with any or all of the other ingredients, amounts, features, elements, and/or embodiments disclosed herein to provide an invention that comprises or consists essentially of such ingredients, amounts, features, elements, and/or embodiments.

The grammatical device “and/or” (such as in “A and/or B”) is used in this disclosure to mean A alone, or B alone, or both A and B. Additionally, the term “substantially perpendicular” means within 5° of perpendicular, and the term “substantially forward” (or rearward) of perpendicular means at least 10° forward (or rearward) of perpendicular.

1. A portal gear box assembly for an all-terrain vehicle or a utility task vehicle, the assembly comprising:
a) a sealed portal gear box housing having an interior housing space defined by a rear wall, a front wall, and a side wall,
wherein the rear wall includes a vehicle axle opening effective to receive an end of an axle of the all-terrain vehicle or the utility task vehicle, and
wherein the front wall includes an output shaft opening effective to receive an end of an output shaft effective to power a vehicle wheel; and
wherein one or more of the housing walls includes a plurality of heat-radiating fins extending from an adjacent outer surface of the housing the wall and effective to radiate heat from the housing at a faster rate than would be radiated in the absence of the fins;
wherein at least two of said plurality of fins each comprise a substantially planar body positioned in a spaced-apart relationship with another of the at least two of said plurality of fins, thus defining a groove therebetween;
and wherein each of the substantially planar bodies comprises a pair of sloped sides extending from the adjacent outer surface of the housing wall, with the sides sloping inward towards each other as the fin extends from the outer surface of the wall, thus causing the groove between the fins to be narrower in the area of the groove closer to the outer surface of the housing wall, and wider in the area of the groove farther away from the outer surface of the housing wall;
b) a set of gears housed in said housing and effective for linking the axle received in the vehicle axle opening to the output shaft received in the output shaft opening;
c) an output shaft operably connectable via said set of gears to the axle received in the vehicle axle opening, and effective to rotate upon rotation of the axle.

2. A portal gear box assembly according to claim 1 wherein the fins extend outward from an adjacent outer surface of the housing.

3. A portal gear box assembly according to claim 1 wherein the fins extend inward from an adjacent outer surface of the housing.

4. A portal gear box assembly according to claim 1 wherein the fins are formed by removing metal from one or more of the walls of the housing.

5. A portal gear box assembly according to claim 1 wherein the fins are removably attached to one or more of the walls of the housing.

6. A portal gear box assembly according to claim 1 wherein the fins are formed integrally with one or more of the walls of the housing.

7. A portal gear box assembly according to claim 1 wherein one or more of the fins comprises a generally rectangular, planer surface extending radially from one or more of the walls of the housing.
